(19) United States
(12) Patent Application Publication
(10) Pub. No.: US 2004/0213223 A1
(43) Pub. Date: Oct. 28, 2004

(54) "Communication apparatus"

(76) Inventors: Mitsumasa Mori, Yokohama (JP); Toshihiko Ogura, Ebina (JP); Toshimichi Noake, Yokohama (JP); Toshiki Ichikawa, Yokohama (JP); Hiroyuki Souma, Hadano (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 09/780,412

(22) Filed: Feb. 12, 2001

(30) Foreign Application Priority Data
Jul. 28, 2000 (JP) 2000-233168

(51) Int. Cl. H04L 12/56

(52) U.S. Cl. 370/389; 370/419; 370/395.1

(57) ABSTRACT

A communication apparatus capable of being connected to networks of a plurality of types, comprising a network discrimination table for discriminating an incoming network of a call setup message, a routing table for selecting an outgoing network of the call setup message, and a control unit for rewriting the contents of an address field and a sub-address field of the received call setup message on the basis of the routing table and transmitting the resultant message to the outgoing network.

### BACKGROUND OF THE INVENTION

(1) Field of the Invention

The present invention relates to an asynchronous transfer mode (hereinafter, referred to as ATM) communication technique and, more particularly, a communication technique using a switched virtual channel (hereinafter, referred to as SVC).

(2) Description of the Related Art

Conventionally, an ATM communicating method using a permanent virtual channel (hereinafter, referred to as PVC) for designating a destination and establishing a connection to the destination in advance and an SVC for designating a destination each time communication starts and establishing a connection to the destination is known. The PVC is adapted to transmit and receive burst data in a real time manner at high speed. On the other hand, the SVC is adapted to dynamically establish a connection of service quality matched to traffic characteristics of various media such as sound, data, and image to an arbitrary destination and perform communications.

In recent years, as the speed of an LAN (Local Area Network) increases, the variety of information to be transmitted increases, the ATM technique widespreads, and the like, it is requested to adopt an ATM network including PVC networks and SVC networks between existing networks such as LAN and telephone network and connect the existing networks by using the SVC. Moreover, there is a demand of selecting an optimum network in accordance with the status of networks and transmitting and receiving information at high speed and economically. In this case, however, there exist a plurality of address systems mixedly in the whole network. Consequently, adjustments of addresses between a received packet and a transmission packet are necessary in a process of transferring information among nodes in the network.

### SUMMARY OF THE INVENTION

An object of the invention is to provide a communication apparatus for realizing a part of a communication path between terminals via a plurality of types of networks by an SVC.

Another object of the invention is to provide a communication apparatus capable of selecting an optimum path in accordance with the status of networks and selectively constructing a part of a communication path between terminals by a PVC or SVC.

In order to achieve the objects, a communication apparatus according to the invention is comprised of: a plurality of input and output ports to be connected to a plurality of types of networks: means for discriminating an incoming network of a message when the message is received from any one of the input ports; means for selecting, on the basis of a predetermined rule, an outgoing network to which the received message is to be sent and rewriting a part of the message; and means for sending out the rewritten received message to an output port corresponding to the outgoing network.

More specifically, a communication apparatus of the invention has: network discriminating means for discriminating the type of an incoming network of a call setup message received from any one of input ports; and outgoing network selecting means for selecting an outgoing network of the call setup message and performing address conversion of the received message. In accordance with the type of the incoming network and the type of the outgoing network of the call setup message, the contents of a first address field and a second address field in the received call setup message is rewritten, thereby setting a connection between terminals. The first address field is, for example, a destination address field of the call setup message, and the second address field is a sub-address field.

To be specific, for example, when the incoming network of the call setup message is a PVC network and the outgoing network of the call setup message is an SVC network, the sub-address of the received message is rewritten to the contents of the destination address field in the message, and the destination address of the received message is rewritten to a pre-registered conversion address. On the contrary, when the incoming network is a PVC network and the outgoing network is an SVC network, the destination address of the received call setup message is rewritten to the contents of the sub-address field in the message, and the call setup message is sent out to an output port connected to the PVC network.

For example, when the incoming network of the call setup message is a public network and the outgoing network of the call setup message is a PVC network, the destination address of the received call setup message is rewritten to a pre-registered conversion address, and the resultant call setup message is sent out to an output port connected to the PVC network. Also in the case where the incoming network is a PVC network and the outgoing network is a public network, the destination address of the received call setup message is rewritten to the pre-registered conversion address, and the call setup message is sent out to an output port connected to the public network.

When the incoming network and outgoing network are of the same type, a received message is transferred in accordance with the contents of the first address field in the received message.

### BRIEF DESCRIPTION OF THE DRAWINGS

FIG. 1 is a diagram showing the configuration of a whole communication network to which a communication apparatus of the invention is applied.

FIG. 2 is a block diagram showing a detailed configuration of a communication apparatus according to the invention.

FIG. 3 is a diagram showing the format of a call setup message.

FIG. 4 is a diagram showing an example of the contents of a network discrimination table 222A of a communication apparatus 120 in the network of FIG. 1.

FIG. 5 is a diagram showing an example of the contents of a routing table 223A of the communication apparatus 120 in the network of FIG. 1.

FIG. 6 is a diagram showing an example of the contents of a network discrimination table 222B of a communication apparatus 121 in the network of FIG. 1.

FIG. 7 is a diagram showing an example of the contents of a routing table 223B of the communication apparatus 121 in the network of FIG. 1.

FIG. 8 is a flowchart showing a process of receiving a call setup message.

FIG. 9 is a flowchart showing a process of transmitting a call setup message.

FIG. 10 is a diagram for explaining a network operation via an SVC network according to the invention.

FIG. 11 is a diagram for explaining a network operation via a PVC network according to the invention.

FIG. 12 is a diagram for explaining a network operation via a public network and an SVC network according to the invention.

FIG. 13 is a diagram for explaining another example of the network operation via the PVC network according to the invention.

### DESCRIPTION OF THE PREFERRED EMBODIMENTS

A communication apparatus having the function of connecting a plurality of types of networks as an embodiment of the invention will be described in detail hereinbelow with reference to the drawings.

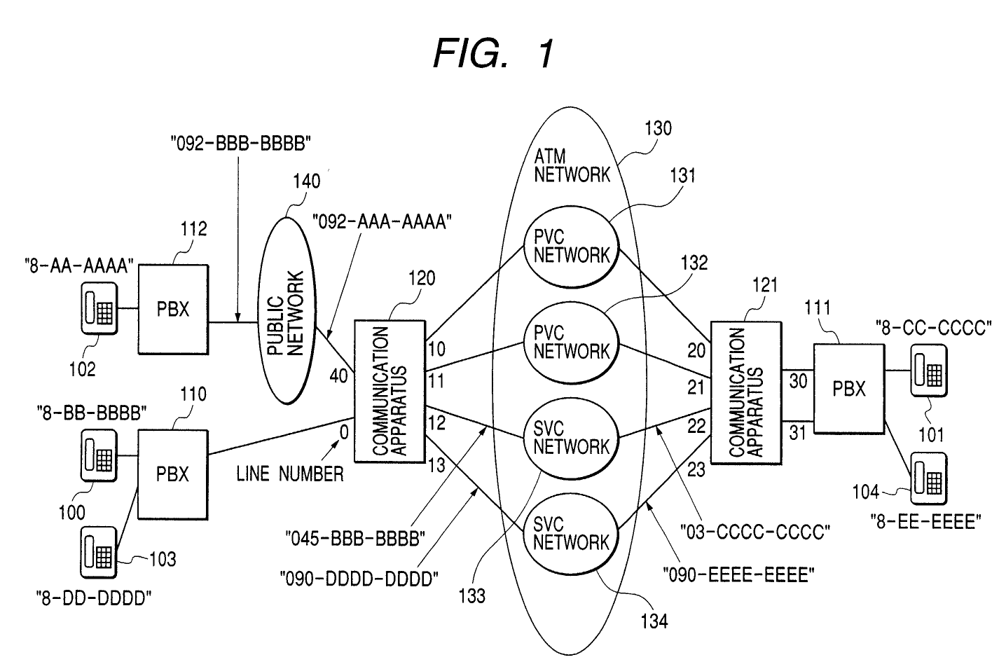

FIG. 1 is a diagram showing the configuration of an entire network. In FIG. 1, terminals 100 and 103 are connected to a communication apparatus 120 via a private branch exchange (hereinbelow, referred to as PBX) 110, a terminal 102 is connected to the communication apparatus 120 via a PBX 112 and a public network 140, and terminals 101 and 104 are connected to a communication apparatus 121 via a PBX 111. The communication apparatus 120 is connected to the communication apparatus 121 via an ATM network 130 constructed by PVC networks 131 and 132 and SVC networks 133 and 134.

In the diagram, reference numerals and characters “8-BB-BBBB”, “8-CC-CCCC”, and the like denote addresses (for example, extension numbers) given to the terminals 100 to 104. Reference numerals and characters “092-AAA-AAAA” and “092-BBB-BBBB” denote addresses (for example, Telephone numbers) given to the public network 140, “045-BBB-BBBB” and “03-CCCC-CCCC” indicate addresses given to the SVC network 133, and “090-DDDD-DDDD” and “090-EEEE-EEEE” indicate addresses given to the SVC network 134. The communication apparatuses 120 and 121 have input and output line ports. Reference numerals 10 to 13 and 20 to 23 are numbers (line numbers) for discriminating lines accommodated by the communication apparatuses 120 and 121.

Each of the communication apparatuses 120 and 121 of the invention has a network discriminating table and a routing table, which will be described in detail hereinafter. The attribute of an incoming network from which a call setup message is received is discriminated by the network discriminating table, and an outgoing network to which the call setup message is sent out is selected by the routing table. By rewriting the address included in the call setup message as necessary, connection to the ATM network 130 can be established.

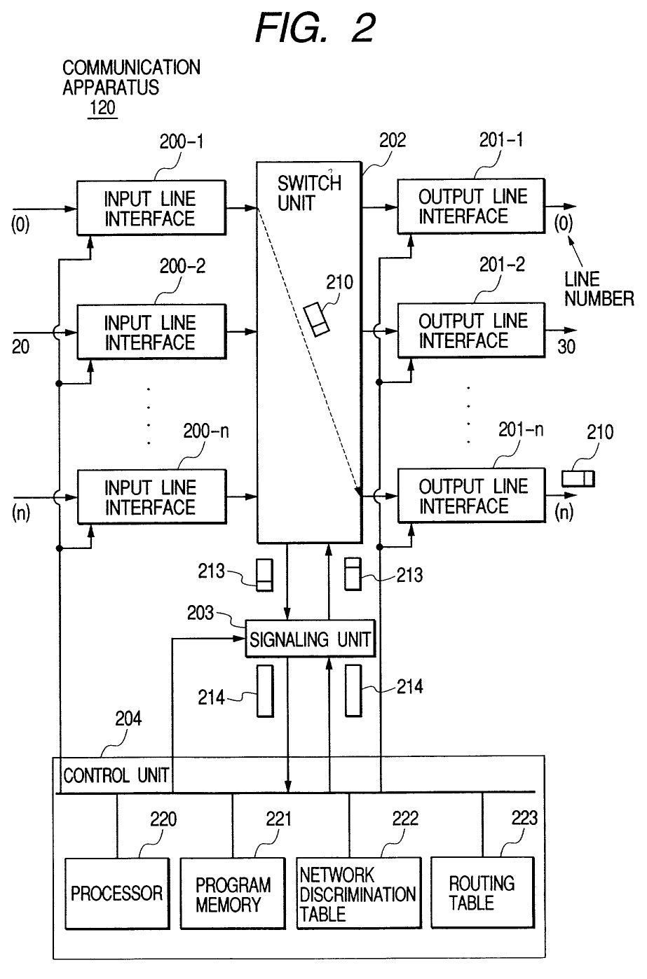

FIG. 2 is a block diagram showing the configuration of the communication apparatus 120. The communication apparatus 121 has the same configuration as that of the communication apparatus 120. The communication apparatus 120 has a plurality of input line interfaces 200-1 to 200-n, a switch unit 202, a plurality of output line interfaces 201-1 to 201-n, a signaling unit 203, and a control unit 204. Each of ATM cells 210 received by the input line interfaces 200-1 to 200-n is switched by the switch unit 202 to one of the plurality of output line interfaces 201-1 to 201-n.

The switch unit 202 outputs signaling cells (control cells) 213 for transferring a call setup message 214 to the signaling unit 203. The signaling unit 203 converts the received signaling cells 213 into the original call setup message 214 and transmits the call setup message 214 to the control unit 204. On the contrary, the signaling unit 203 converts a call setup message 214 received from the control unit 204 to one or a plurality of signaling cells 213 and transmits the signaling cells to the switch unit 202. When signaling cells 213 are converted to the call setup message 214, the signaling unit 203 adds incoming line discriminating information extracted from the internal header of each signal cell 213 to the call setup message 214.

The control unit 204 has a processor 220, a program memory 221, a network discrimination table 222, and a routing table 223 and controls over the input line interfaces 200-1 to 200-n, output line interfaces 201-1 to 201-n, switch unit 202, and signaling unit 203.

In the program memory 221, control programs such as a program for network connecting processing to be executed by the processor 220 are stored. The network discrimination table 222 is used to judge an incoming network of the call setup message 214 and storing the types and the like of the incoming networks. The routing table 223 is used to select an outgoing network of the call setup message 214 and storing the type, status, address (conversion address) and the like of the outgoing network. In the communication apparatus 120 (121) of the invention, the processor 220 in the control unit 204 analyzes the call setup message 214 and performs a process of connecting the incoming network and the ATM network 130 on the basis of the network discrimination table 222 and the routing table 223.

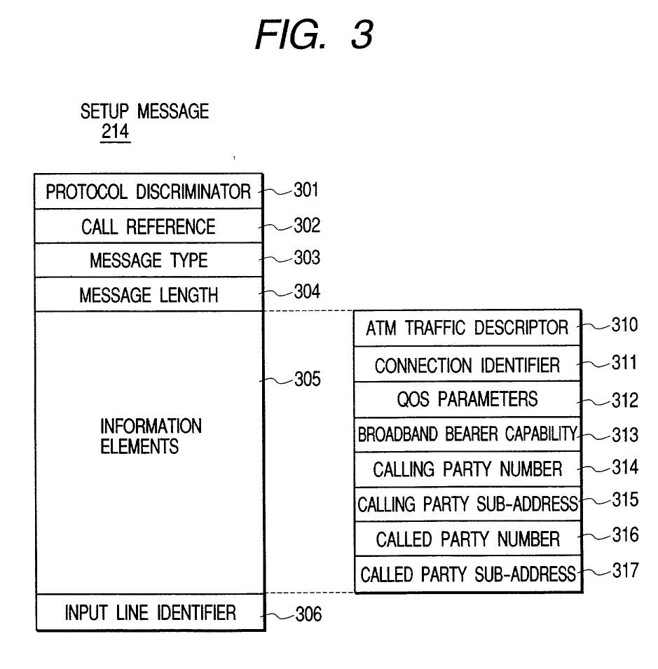

FIG. 3 shows the format of the call setup message 214. The call setup message 214 is constructed in compliance with the ITU-T recommendation Q.2931 and includes protocol discriminator 301, call reference 302, message type 303, message length 304, and information elements 305. The information elements 305 include ATM traffic descriptor 310, connection identifier 311, QoS parameters 312, broadband bearer capability 313, calling party number 314, calling party sub-address 315, called party number 316, and called party sub-address 317. Input line identifier 306 shown in FIG. 3 is added by the signaling unit 203 as described above and is used by the control unit 204 to search the network discrimination table 222.

In the communication apparatus of the invention and a network using the communication apparatus, the connection between terminals via a plurality of types of networks can be established by using the called party number 316 and the called party sub-address 317 as described hereinafter.

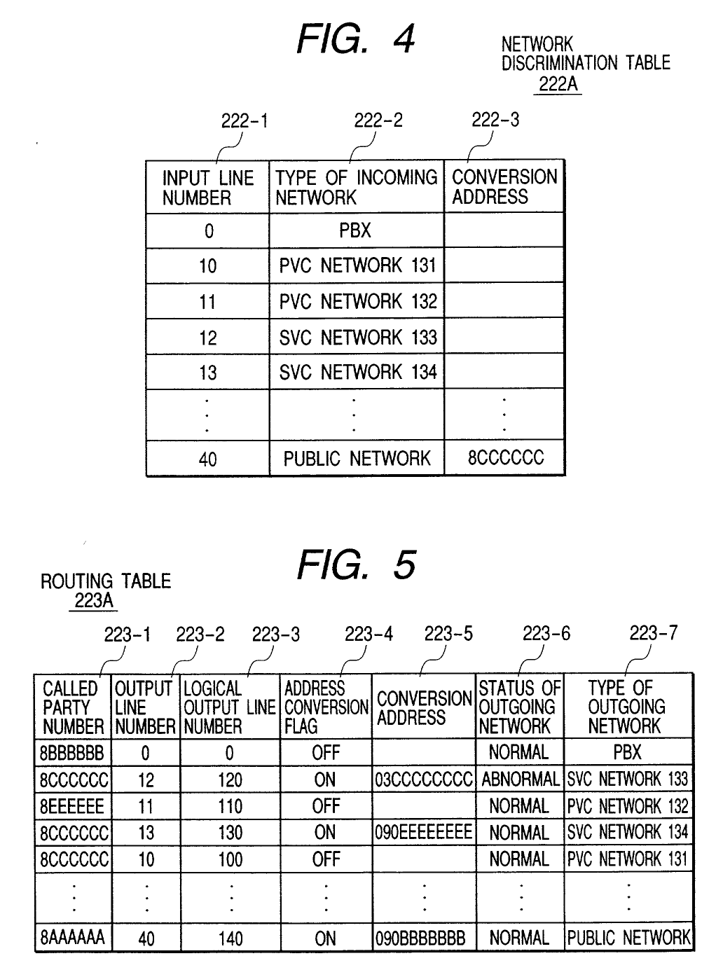

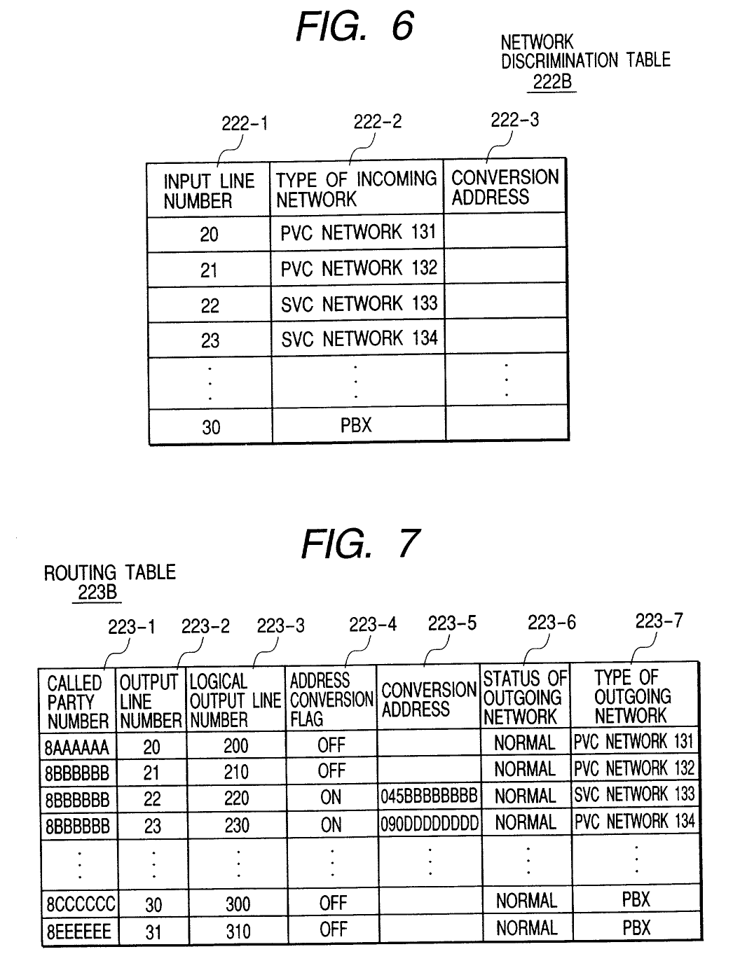

FIGS. 4 and 6 show the configurations of network discrimination tables 222A and 222B of the communication apparatuses 120 and 121, respectively. The network discrimination table 222A (222B) stores information indicative of discrimination number (for example, line number) 222-1 of each of input lines accommodated by the communication apparatus 120 (121) , type 222-2 of a network (incoming network) connected to the input line, and conversion address (for example, extension) 222-3.

FIGS. 5 and 7 show the configurations of the routine tables 223A and 223B of the communication apparatuses 120 and 121, respectively. The routing table 223A (223B) stores information indicative of called party number 223-1 used by the communication apparatus 120 (121) to obtain the destination of the call setup message 214, output line number 223-2, logical output line number 223-3 of the destination, address conversion flag 223-4 indicative of the presence or absence of a conversion address, conversion address 223-5, status 223-6 of an outgoing network, and a type 223-7 of the outgoing network.

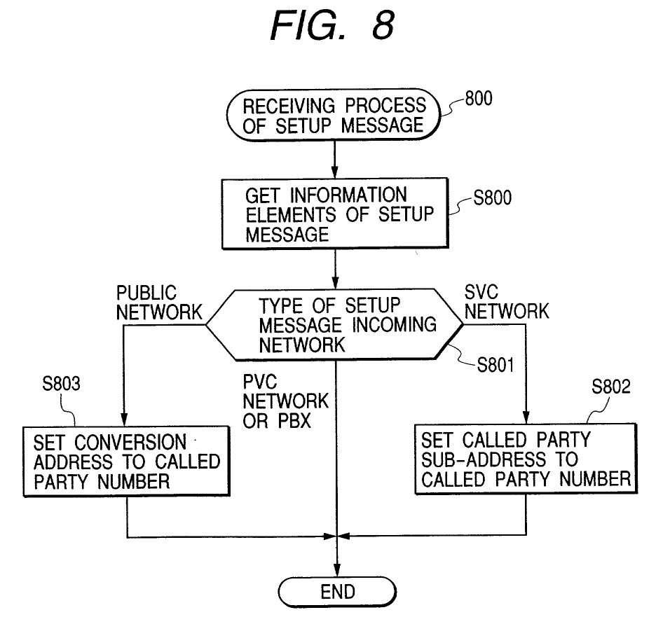

FIG. 8 is a flowchart showing the procedure of a receiving process of the call setup message 214. In the call setup message receiving process 800, first, the received call setup message 214 is analyzed (step S800). The network discrimination table 222A (222B) is searched on the basis of the input line identifier 306 added to the call setup message 214, and the type 222-2 of the incoming network of the call setup message 214 is discriminated (S801). When the incoming network of the call setup message 214 is an SVC network, the contents of the called party sub-address 317 is set to the called party number 316 of the call setup message 214 (S802) . When the incoming network of the call setup message 214 is a public network, the conversion address 222-3 obtained from the network discrimination table is set to the called party number 316 (S803).

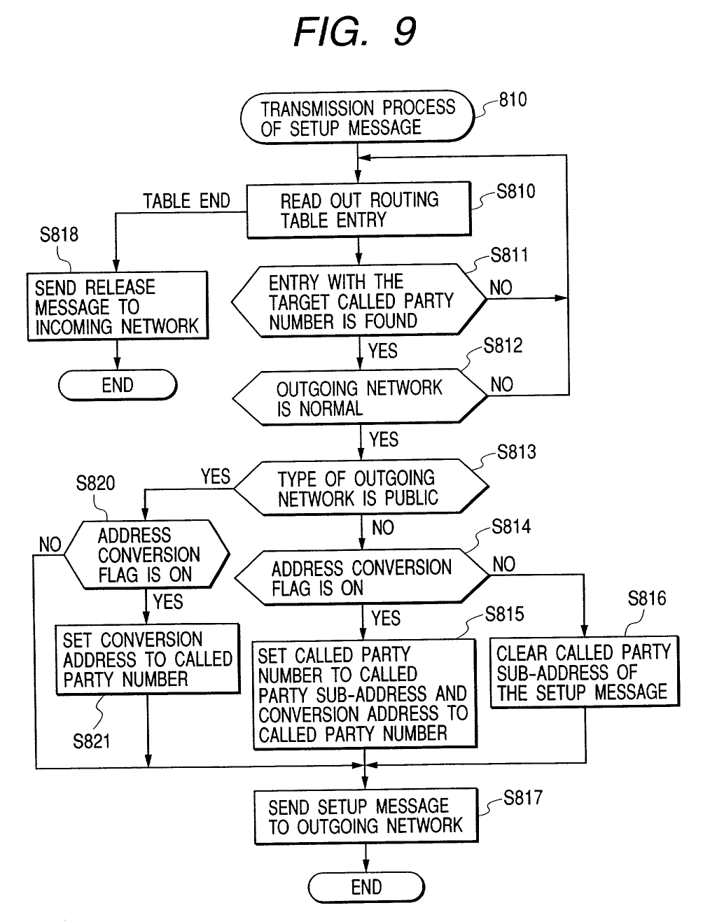

FIG. 9 is a flowchart showing the procedure of a transmission process of the call setup message 214. In a call setup message transmission process 810, the routing table 223A (223B) is searched on the basis of the called party number 316 of the call setup message 214 which is determined in the receiving process 800. Specifically, entries are sequentially read out from the routing table (step S810) , and whether the called party number of the table entry coincides with called party number 316 or not is determined (S811).

When the called party number 223-1 of the table entry coincides with the called party number 316, whether the status 223-6 of the outgoing network is normal or not is determined (S812). If the status 223-6 of the outgoing network is not normal, the program sequence returns to step S810. If the status 223-6 of the outgoing network is normal, whether the type 223-7 of the outgoing network for the call setup message 214 is a public network or not is further determined (S813).

When the type 223-7 of the outgoing network is not a public network, whether the address conversion flag is set (ON) state or not is determined (S814). If the address conversion flag 223-4 is ON state, the contents of the called party number 316 is set to the called party sub-address 317 of the call setup message 214, and the conversion address 223-5 in the routing table 223 is set as a destination address into the called party number 316 of the call setup message 214 (S815). After that, the call setup message 214 is transmitted to the outgoing network indicated by the output line number 223-2 (S817). If the address conversion flag 223-4 is reset (OFF) state in step S814, the contents of the called party sub-address 317 of the call setup message 214 is cleared so that the called party number 316 of the call setup message 214 becomes a destination address (S816) After that, the call setup message 214 is sent out to the outgoing network indicated by the output line number 223-2 (S817).

When the type 223-7 of the outgoing network of the call setup message 214 is a public network in step S813, whether the address conversion flag 223-4 is set (ON) state or not is determined (S820) If the address conversion flag 223-4 is ON state, the contents of the conversion address 223-5 of the routing table 223 is set as a destination address into the called party number 316 of the call setup message 214 (S821) and, after that, the call setup message 214 is transmitted to an outgoing network indicated by the output line number 223-2 (S822). If the address conversion flag 223-4 is OFF state, the call setup message 214 is sent out to the outgoing network by using the called party number 316 as a destination address (S817) When all of the entries in the routing table 223 are read out in step S810, a release message 214 is transmitted to the incoming network of the call setup message 214 (S818).

By the above procedure, the terminals having a plurality of types of communication networks therebetween can be connected by using the SVC. An optimum path can be selected in accordance with the status in the ATM network and terminals can be connected by using the SVC.

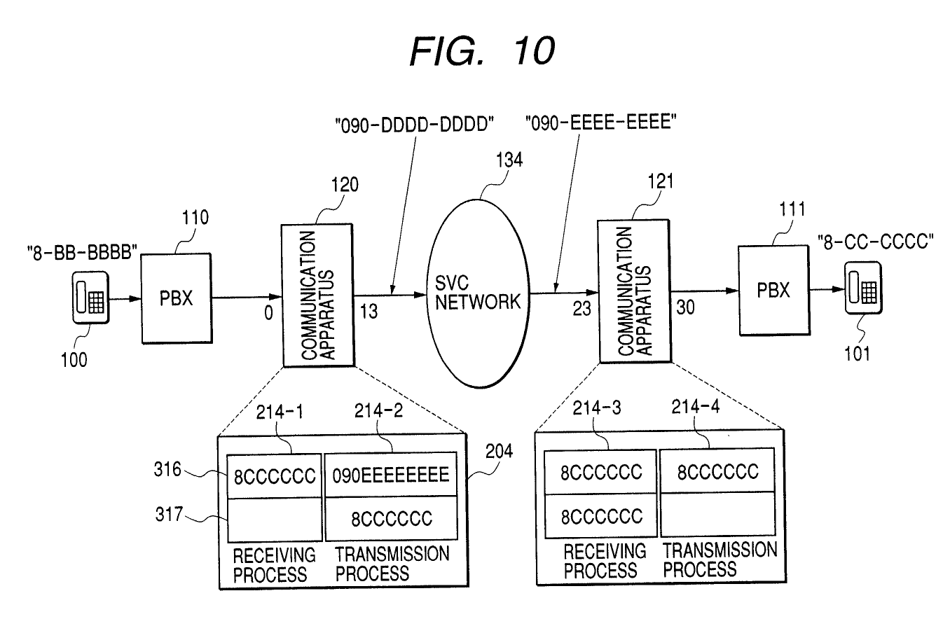

Referring to FIG. 10, an example of the operations of the communication apparatuses 120 and 121 according to the invention will be described in the case where a call is made from the terminal 100 to the terminal 101 via the SVC network 134.

When a call is made from the terminal 100 to the extension 8-CC-CCCC of the terminal 101, by referring to the network discrimination table 222A on the basis of the input line identifier 306 (input line number “0” in this example) added to the call setup message 214 issued from the terminal 100, the communication apparatus 120 discriminates the type 222-2 of the incoming network of the call setup message 214 (S801). In the network discrimination table 222A shown in FIG. 4 as an example, the incoming network corresponding to the input line number “0” is a PBX. Consequently, the communication apparatus 120 performs transmission processing on the call setup message 214 by using the called party number 316 of the call setup message 214 as the destination address. At this time point, as shown by 214-1 in FIG. 10, “8CCCCCC” is set as the called party number 316 and the called party sub-address 317 is blank in the call setup message 214.

The communication apparatus 120 searches the routing table 223A on the basis of the called party number “8CCCCCC” in the call setup message 214-1 (S810 and S811). In the routing table 223A as shown in FIG. 5, there exist a plurality of entries (second, fourth, and fifth entries) having the called party number “8CCCCCC”. In the searching steps S810 and S811, the second entry is retrieved first as an entry having the called party number “8CCCCCC”. However, the second entry is ignored because the status 223-6 of the outgoing network is “abnormal”. As the next entry, the fourth entry is retrieved. In the fourth entry, the status 223-6 of the outgoing network is “normal” and the address conversion flag 223-4 is ON state. Accordingly, the communication apparatus 120 sets, as shown by 214-2, the called party number “8CCCCCC” to the called party sub-address 317 and “090EEEEEEEE” indicated as the conversion address 223-5 in the fourth entry to the called party number 316 of the call setup message 214 and, after that, transmits the resultant call setup message 214 to an outgoing SVC network having the output line number 13 and the logical line number 130 (S817) It is understood from the example that, according to the invention, an optimum outgoing network can be selected in accordance with the network status.

When the call setup message 214-2 is received from the SVC network 134, the communication apparatus 121 refers |to the network discrimination table 222B shown in FIG. 6 on the basis of the input line identifier 306 (in the example, input line number “23”) added to the call setup message 214-2, and discriminates that the type 222-2 of the incoming network of the call setup message 214 is the SVC network (S801). The communication apparatus 121, therefore, sets the called party sub-address 317 of “8CCCCCC” as the called party number 316 of the call setup message as shown by 214-3 in FIG. 10 (S802)

Then the communication apparatus 121 searches the routing table 223B shown in FIG. 7 on the basis of the called party number 316 of “8CCCCCC” in the call setup message 214-3 (S810 and S811). As an entry having the called party number “8CCCCCC”, the second entry from the last in the routing table 223B is retrieved. In this entry, the status 223-6 of the outgoing network is “normal”, the address conversion flag 223-4 is OFF state, and the type of the outgoing network is “PBX”. Consequently, as shown by 214-4, the communication apparatus 121 clears the called party sub-address 317 of the received call setup message 214-3 (S816) , and transmits the call setup message to the outgoing network, which is the PBX 111 having output line number “30” and logical line number “300”, by using the called party number 316 as the destination address (S817). According to the above operations of the communication apparatuses 120 and 121, the terminal 100 can communicate with the terminal 101 through the SVC connection.

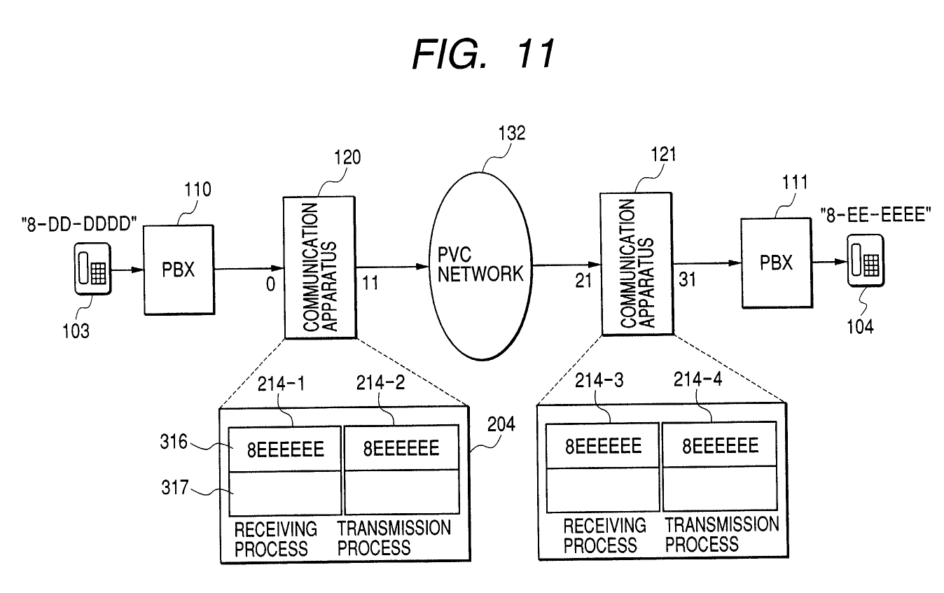

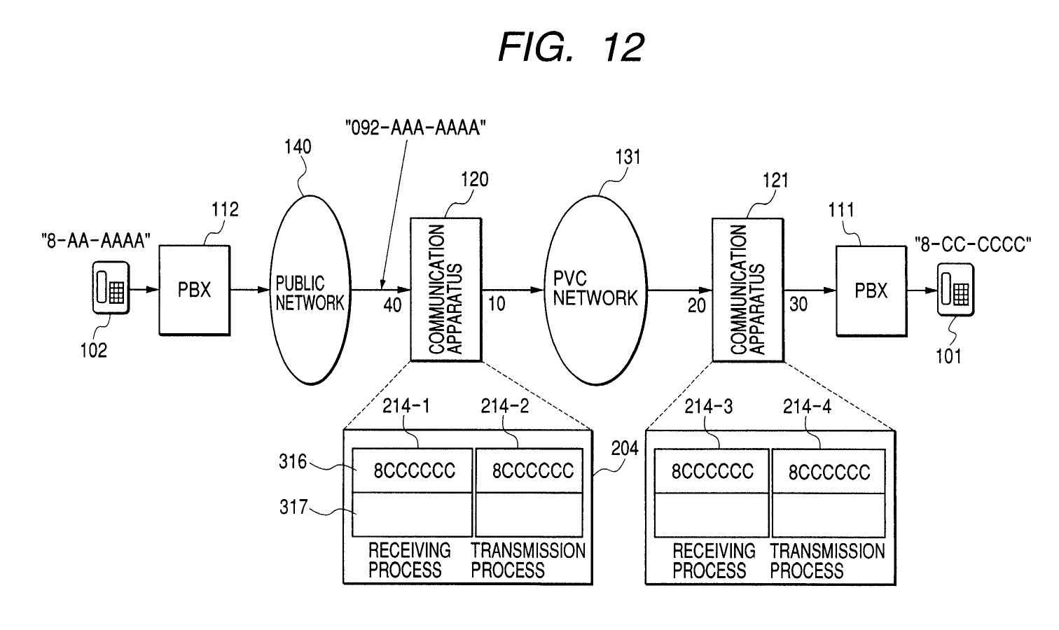

Referring to FIG. 11, another example of operations of the communication apparatuses 120 and 121 according to the invention will now be described in the case where a call is made from the terminal 103 to the terminal 104 via the PVC network 132.

When a call is made from the terminal 103 to the extension “8-EE-EEEE” of the terminal 104, the communication apparatus 120 discriminates the type 222-2 of the incoming network of the call setup message 214 as a PBX (S801) by referring to the network discrimination table 222A on the basis of the input line identifier 306 (input line number “0”) added to the call setup message. When the incoming network is a PBX, as shown in FIG. 8, address conversion is not performed in the call setup message receiving process 800, and the received message is transferred by using the called party number 316 as a destination address. The call setup message at this time point is indicated by 214-1.

The communication apparatus 120 searches the routing table 223A on the basis of the called party number “8EEEEEE” set in the call setup message 214-1 (S810 and S811). As an entry having the called party number “8EEEEEE”, the third entry is retrieved from the routing table 223A. It is found from the entry that the status 223-6 of the outgoing network is “normal”, the address conversion flag 223-4 is OFF state, and the type of the outgoing network is a “PVC network”. In this case, the called party sub-address 317 is cleared (S816), and the call setup message is sent out to the outgoing network, which is the PVC network 132 having the output line number “11” and the logical line number “110”, by using the called party number 316 as a destination address (S817). The call setup message at this time point is shown by 214-2.

When the call setup message 214-2 is received from the PVC network 132, the communication apparatus 121 refers to the network discrimination table 222B on the basis of the input line identifier 306 (input line number “21”) added to the call setup message, and discriminates that the type 222-2 of the incoming network of the call setup message is the PVC network 132. In this case, the address conversion in the call setup message receiving process 800 is not performed, and the received message is transferred using the called party number 316 as a destination address. The call setup message at this time point is shown by 214-3.

The communication apparatus 121 searches the routing table 223B shown in FIG. 7 on the basis of the called party number “8EEEEEE” in the call setup message 214-3 (S810 and S811) . As an entry having the called party number “8EEEEEE”, the last entry is retrieved from the routing table 223B, and it is found that the status 223-6 of the outgoing network is “normal”, the address conversion flag 223-4 is “OFF” state, and the type of the outgoing network is “PBX”. The communication apparatus 121, therefore, clears the called party sub-address 317 of the call setup message (S816) and sends out the call setup message to the outgoing network, which is the PBX 111 having the output line number “31” and the logical line number “310”, by using the called party number 316 as a destination address (S817). The call setup message at this time point is shown by 214-4.

As described above, according to the invention, the terminal 103 can communicate with to the terminal 104 through the connection via the PVC network 132.

Referring to FIG. 12, the operations of the communication apparatuses 120 and 121 according to the invention will be described in the case where a call is made from the terminal 102 to the terminal 101 via the public network 140 and the SVC network 134.

In the case of making a call from the terminal 102 to extension “8-CC-CCCC” of the terminal 101, since the PBX 112 is connected to the public network 140, the call setup message 214 is transmitted to the public network 140 in a form in which the public network address “092AAAAAAA” is set as the called party number 316. The communication apparatus 120 refers to the network discrimination table 222A on the basis of the input line identifier 306 (input line number “40”) added to the call setup message 214, and recognizes that the incoming network of the call setup message 214 is a public network and the conversion address 222-3 is “8CCCCCC”.

In the case where the incoming network is a public network, the value “8CCCCCC” of the conversion address 222-3 is set as the called party number 316 of the call setup message 214 by the process of receiving the call setup message shown in FIG. 8 (S803). The call setup message at this time point is shown by 214-1. Since the subsequent processes on the call setup message 214-1 are similar to those in FIG. 11, the detailed description is omitted here. From the above description, according to the invention, the communication between the terminals connected to the PBXs can be realized by the connection including the public network.

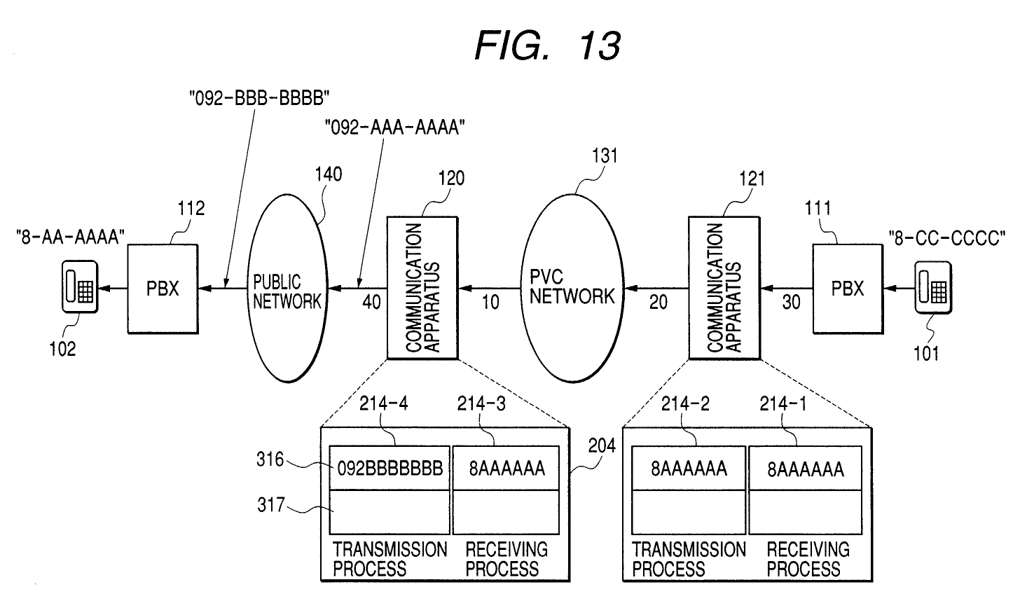

With reference to FIG. 13, operations of the communication apparatuses 120 and 121 will be described in the case where a call is made from the terminal 101 to the terminal 102 in FIG. 12. The operations of the communication apparatus 121 are performed in a manner similar to those of the communication apparatus 120 described in FIG. 11. Reference numerals 214-1 and 214-2 denote the status of the call setup message in the receiving process and that in the transmitting process by the communication apparatus 121, respectively.

The receiving operation by the communication apparatus 120 for the call setup message 214-2 received from the PVC network 131 is performed in a manner similar to the receiving operation in the communication apparatus 121 described in FIG. 11. The call setup message at this time point is shown by 214-3.

The communication apparatus 120 searches the routing table 223A on the basis of the called party number “8AAAAAA” in the call setup message 214-3 (S810 and S811). As an entry having the called party number “8AAAAAA”, the last entry in the routing table 223A is retrieved. It is found from the entry that the status 223-6 of the outgoing network is “normal”, the address conversion flag 223-4 is ON state, and the type of the outgoing network is a public network. The communication apparatus 120 therefore sets the value “092BBBBBBB” indicated by the conversion address 223-5 into the called party number 316 in the call setup message (S821), and sends out the call setup message to the outgoing network, which is the public network 140 having the output line number “40” and the logic circuit number “140” (S822) “092BBBBBBB” may be a number which serves as both the telephone number of the public network and the extension of a private network. When “092BBBBBBB” is a number dedicated to the public network, it is converted to extension number for the private network by the PBX 112.

As described above, according to the invention, the communication between the terminals accommodated by the PBXs can be realized by connecting the PBX and the public network via the SVC. As obviously understood from the embodiments, by the communication apparatus according to the invention, the optimum path can be selected according to the status of the outgoing network, and the communication path between terminals via a plurality of types of networks can be constructed.

What is claimed is:

1. A communication apparatus having a plurality of input and output ports to be connected to a plurality of types of networks, comprising:
means for discriminating the type of an incoming network of a connection setup request when the connection setup request is received from any one of said input ports and; and
means for selecting an outgoing network in said connection setup request on the basis of a predetermined rule, and transferring the connection setup request to an output port connected to said outgoing network after rewriting a part of the connection setup request.

2. A communication apparatus having a plurality of input and output ports to be connected to a plurality of types of networks, comprising:
means for discriminating an incoming network of a received message when the message is received from one of said input ports; and
means for selecting an outgoing network of said received message on the basis of a predetermined rule, and transferring the received message to an output port connected to said outgoing network after rewriting a part of the received message.

3. A communication apparatus having a plurality of input and output ports to be connected to a plurality of types of networks, comprising:
first means for discriminating an incoming network of a received message when the message is received from one of said ports; and
second means for selecting an outgoing network of said received message on the basis of a predetermined rule, and transmitting said received message to an output port connected to said outgoing network after selectively rewriting the contents of a first address field and a second address field in the received message.

4. A communication apparatus according to claim 3, wherein when the incoming network of said received message is a network of a first type and an outgoing network is a network of a second type, said second means sends out said received message to an output port connected to said outgoing network after writing the contents of said first address field into said second address field and an address corresponding to the network of the second type obtained on the basis of said predetermined rule into said first address field.

5. A communication apparatus according to claim 3, wherein when an incoming network and an outgoing network of said received message are networks of a first type, said second means sends out said received message to an output port connected to the outgoing network by using the contents of said first address field.

6. A communication apparatus according to claim 3, wherein when the incoming network of said received message is a network of a first type and the outgoing network is a network of a third type, said second means writes an address corresponding to the network of the third type obtained on the basis of the predetermined rule into said first address field, and sends out the received message to an output port connected to the outgoing network.

7. A communication apparatus according to claim 3, wherein when the incoming network of said received message is a network of a third type and the outgoing network is a network of a first type, said second means sends out said received message to an output port connected to the outgoing network by using the contents of said first address field.
